(19) United States
(12) Patent Application Publication
(10) Pub. No.: US 2007/0150442 A1
(43) Pub. Date: Jun. 28, 2007

(54) Library services in communication networks

(76) Inventors: Frances Mu-Fan Chin, Naperville, IL (US); Peggy H. Hasan, Aurora, IL (US); Huixian Song, Naperville, IL (US); Sandra L. True, St. Charles, IL (US)

Correspondence Address: DUFT BORNSEN & FISHMAN, LLP, 1526 SPRUCE STREET, SUITE 302, BOULDER, CO, 80302, US

(21) Appl. No.: 11/312,174

(22) Filed: Dec. 20, 2005

(51) Int. Cl. G06F 17/30

(52) U.S. Cl. 707/3

(57) ABSTRACT

Communication networks, phones, and associated methods are disclosed that provide library services to users of phones. A phone displays a library search screen to a user, and the user enters one or more library search parameters. The phone generates a request message that includes the library search parameter(s), and transmits the request message to a communication network (e.g., a wireless network or a VoIP network). A library server in the communication network receives the request message, and queries a library database based on the library search parameter(s). The library server receives library search results from the library database, and determines the type of response (e.g., text message, email message, etc) for the library search results. The library server then formats the library search results based on the determined type of response, and transmits the response to the user.

### BACKGROUND OF THE INVENTION

1. Field of the Invention

The invention is related to the field of communication networks, and in particular, to providing library services in communication networks to allow users of phones to search for information on books, music, manuscripts, etc.

2. Statement of the Problem

Cellular phones, PCS phones, and other mobile wireless devices have become very popular due to the conveniences that they provide to people. Cell phones have become compact in size, which make them easy and convenient to carry. People routinely carry their cell phones with them on their belt, in their pocket, in their purse, etc, so they are available for use at any time.

Because of the large demand for cell phone service, service providers strive to offer new services to current and potential customers. One service offered by many service providers is text messaging services, such as Short Message Service (SMS). With the text messaging service, a subscriber may send and receive messages through their cell phone. The subscriber may also sign up for services that send informational text messages to their phone, such as information on the weather, information on traffic reports, advertisements, etc. The cell phone may request the informational text messages or may automatically receive the informational text messages periodically.

In all of the services currently offered by service providers, they have yet to provide an effective way of obtaining library information from a phone. Library information may be useful for general information on books, music, etc, or may be used as learning or reference tools for parents, teachers, etc. For instance, parent and/or teachers who see a child reading a book may want to know if the content of the book is appropriate for the age and reading level of the child.

Some wireless subscribers may subscribe to web-based services that allow their phones to receive data through a web browser. The web browsers may be used to “surf” the Internet for content, such as library information. However, not all wireless subscribers subscribe to web-based services, and even those that do may not be technically advanced enough to use the services. Therefore, it may be desirable for service providers to offer library services to subscribers outside of the web-based applications.

### SUMMARY OF THE SOLUTION

The invention solves the above and other related problems by configuring a phone and a communication network to provide library services to a user of the phone. The phone is configured to receive library search parameters from a user, and include the library search parameters in a request message. Responsive to receiving the request message, a library server in the communication network recognizes the library search parameters in the request message, and queries a library database with the library search parameters. The library server receives library search results from the library database, and determines the type of response for the library search results. The type of response, such as a screen display on the phone, a text message, a voice message, an email message, etc, may depend on predefined user preferences, may be determined by the library server based on the size of the results, etc. The library server then transmits the library search results to the user based on the determined type of response.

Advantageously, a user of a phone has access to one or more library databases to find library information as desired. The user can access the library service through his/her phone, which may be convenient depending on the location of the user. The library services are available to the user even if the user is not set up with web-based capabilities or does not know how to use the web-based capabilities.

In one embodiment of the invention, a phone is adapted to display a library search screen to a user. The user enters one or more library search parameters into the phone. The phone generates a request message that includes the library search parameter(s), and transmits the request message to a communication network. The phone may subsequently receive a response message from the communication network that includes library search results based on the library search parameter(s). The phone may display the library search results to the user.

In another embodiment, a communication network includes a library server adapted to receive a request message from a phone, where the request message includes one or more library search parameters entered by the user of the phone. The library server queries one or more library databases based on the library search parameter(s). The library server may format a query message according to a desired format of the library database. The library server receives library search results from the library database. Responsive to receiving the library search results, the library server determines the type of response for the library search results. The type of response, such as a screen display on the phone, a text message, a voice message, an email message, etc, may depend on predefined user preferences or may be determined by the library server based on the size of the results. The library server then formats the library search results based on the determined type of response, and transmits the response to the user.

The invention may include other exemplary embodiments described below.

### DESCRIPTION OF THE DRAWINGS

The same reference number represents the same element on all drawings.

FIG. 1 illustrates a communication network in an exemplary embodiment of the invention.

FIG. 2 is a flow chart illustrating a method of operating a phone in an exemplary embodiment of the invention.

FIG. 3 is a flow chart illustrating a method of operating a communication network in an exemplary embodiment of the invention.

FIG. 4 is a flow chart illustrating a method of further operating a phone in an exemplary embodiment of the invention.

FIG. 5 illustrates a wireless network in an exemplary embodiment of the invention.

FIG. 6 illustrates an exemplary library search screen provided to a user by a mobile phone.

FIG. 7 illustrates an exemplary library search results screen provided to a user by a mobile phone.

### DETAILED DESCRIPTION OF THE INVENTION

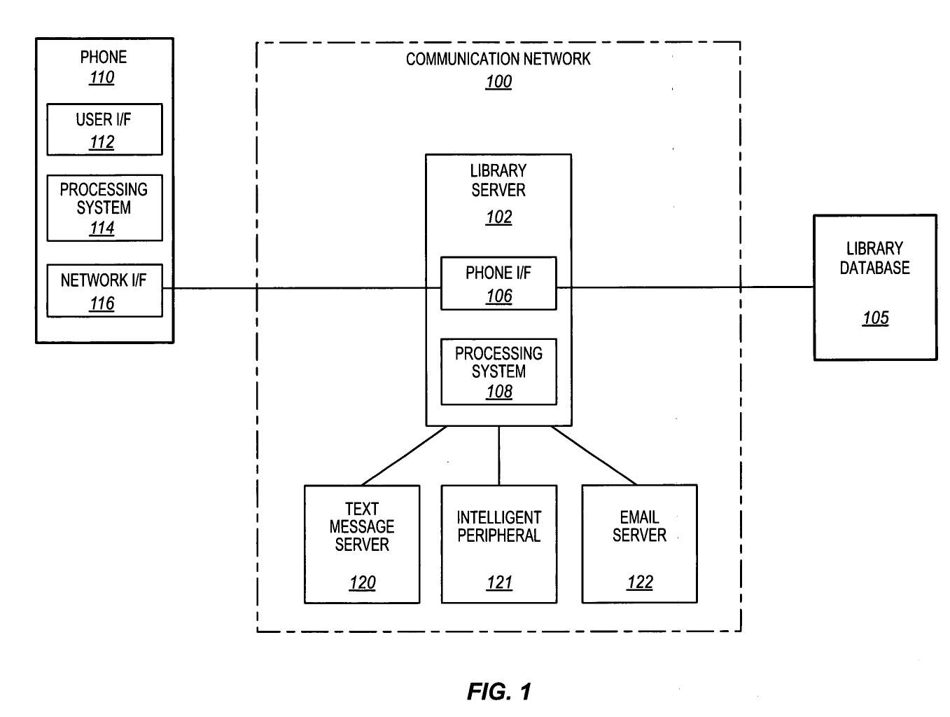

FIGS. 1-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise a wireless network configured to provide wireless voice communications. Communication network 100 may alternatively comprise a packet-based network configured to provide voice communications, such as an IP Multimedia Subscriber (IMS) network or any other type of VoIP network. Communication network 100 may include a library server 102, a text message server 120, an Intelligent Peripheral (IP) 121, and an email server 122. Library server 102 is adapted to communicate with a phone 110 and a plurality of other phones (not shown). There may be other intermediate systems, routers, base stations, etc, between library server 102 and phone 110 that are not shown in FIG. 1. Library server 102 is also adapted to communicate with a library database 105. Communication network 100 may include other networks, systems, or devices not shown in FIG. 1.

Library server 102 is a system that interfaces a phone with a library database. Library server 102 may comprise an intelligent peripheral, a Mobile Switching Center (MSC), or another system in an intelligent wireless network. Library server 102 may alternatively comprise a VoIP application server, an IMS application server, an IMS Home Subscriber Server (HSS), or another system in a packet-based network. In this embodiment, library server 102 includes a phone interface 106 and a processing system 108.

Library database 105 comprises any system or server that stores library information, such as information on books, computer files, manuscripts, cartographic materials, music, sound recordings, visual materials, etc. Library database 105 is illustrated as outside of communication network 100. The purpose of this is to show that library server 102 may communicate with remote library databases not owned or maintained by the service provider. For instance, library database 105 may comprise a public or commercial library database on the Internet that is available to Internet users. One example of a public library database is the Library of Congress Online Catalog. Communication network 100 may also include a local library database.

Text message server 120 comprises any server or system adapted to generate and transmit text messages, such as a Short Message Service Center (SMSC). Intelligent peripheral 121 comprises any server or system adapted to generate and transmit voice messages. Email server 122 comprises any server or system adapted to generate and transmit email messages.

Phone 110 comprises any communication device adapted to provide voice and/or data communications. Phone 110 may comprise a wireline VoIP phone, a wireless VoIP phone, or a non-VoIP wireless phone (e.g., a cell phone). If phone 110 comprises a VoIP phone, then phone 110 may initiate and terminate VoIP calls according to SIP protocol or another protocol. If phone 110 comprises a cell phone, then phone 110 may initiate and terminate calls according to SS7 protocol, IS-41 protocol, etc. In this embodiment, phone 110 includes a user interface 112, a processing system 114, and a network interface 116. User interface 112 may comprise a keypad, a display, a touch-screen, a pointing device, and/or any other interface.

According to features and aspects herein, phone 110 and communication network 100 are adapted to provide a library service to a user (not shown) of phone 110. Assume that the user wants to find information on a book, an article, a song, etc. The user can access the library service through phone 110 to find the desired library information.

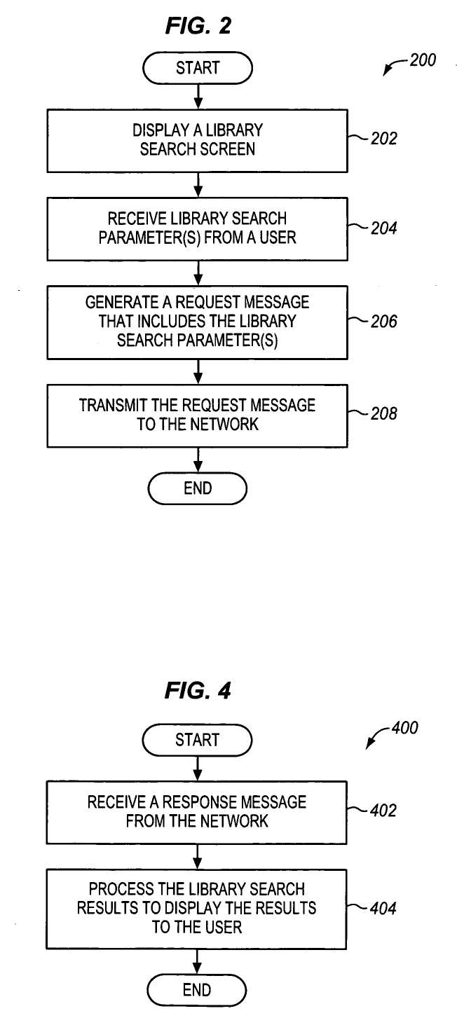

FIG. 2 is a flow chart illustrating a method 200 of operating phone 110 in an exemplary embodiment of the invention. The steps of method 200 will be described with reference to phone 110 in FIG. 1. The steps of the flow chart in FIG. 2 are not all inclusive and may include other steps not shown.

In step 202, user interface 112 displays a library search screen to the user. The library search screen is not intended to be an HTML search screen provided by library database 105, such as the Library of Congress Online Catalog, through a web browser on phone 110. The library search screen is a screen generated by phone 110 based on a library service application running on processing system 114.

Through the library search screen, the user enters one or more library search parameters into phone 110, and user interface 112 receives the library search parameter(s) in step 204. Library search parameters comprise any identifying information used to search for library information. Library information comprises any information on materials typically kept in a library. For instance, library information may comprise information on a book, information on a song, etc. As such, library search parameters may comprise one or more key words on a title or an author, a Library of Congress Control Number (LCCN), an International Standard Book Number (ISBN), an International Standard Serial Number (ISSN), etc.

Responsive to receiving the library search parameter(s), processing system 114 generates a request message in step 206. Processing system 114 includes the library search parameter(s) in the request message. In step 208, network interface 116 transmits the request message to communication network 100. If phone 110 comprises a VoIP phone, then the request message may comprise a SIP message. If phone 110 comprises a cell phone, then the request message may comprise a signaling message used by the cell phone.

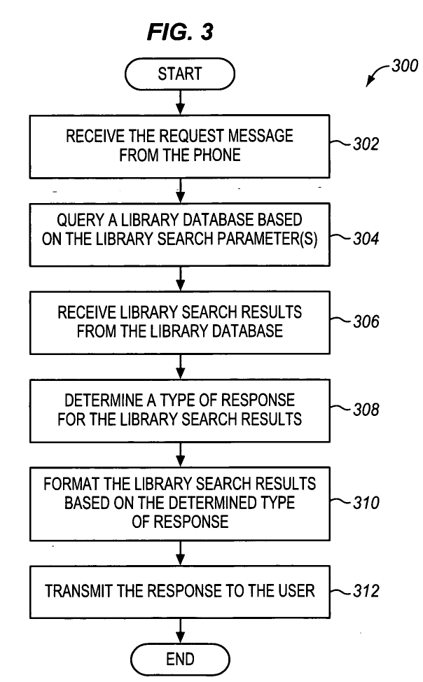

FIG. 3 is a flow chart illustrating a method 300 of operating communication network 100 in an exemplary embodiment of the invention. The steps of method 300 will be described with reference to communication network 100 in FIG. 1. The steps of the flow chart in FIG. 3 are not all inclusive and may include other steps not shown.

In step 302, phone interface 106 of library server 102 receives the request message from phone 110. As described above, the request message includes one or more library search parameters entered by the user of phone 110. Library server 102 may have to authenticate the user of phone 110 at this time or may have previously authenticated the user.

In step 304, processing system 108 queries library database 105 based on the library search parameter(s). Processing system 108 may query other library databases not shown. As part of querying a library database 105, processing system 108 may format a query message that includes the library search parameter(s), based on a format understood or desired by the library database.

In step 306, processing system 108 receives library search results from library database 105. Library search results comprise one or more records found based on the library search parameter(s). A record may comprise an author, a title, a brief description, etc. The library search results may include a single record or a plurality of records. The number of records in the search results generally depends on the detail of the search parameter(s).

Responsive to receiving the library search results, processing system 108 determines a type of response for providing the library search results to the user in step 308. For instance, the type of response may be a response message causing phone 110 to provide a display screen to the user showing the library search results. The response message may be transmitted over a signaling channel or over an established bearer channel. Another example of a type of response is a text message transmitted to phone 110. Another example of a type of response is a voice message transmitted to phone 110. Another example of a type of response is an email message transmitted to an email address specified by the user of phone 110.

In step 310, processing system 108 formats the library search results based on the determined type of response. In step 312, processing system 108 transmits the response to the user. If the determined type of response comprises display screen for phone 110, then processing system 108 may generate a response message that includes the library search results. Processing system 108 then transmits the response message to phone 110 over a signaling or bearer channel for display of the library search results to the user.

If the determined type of response comprises a text message, then processing system 108 may transmit the library search results to text message server 120. Text message server 120 receives the library search results, generates a text message based on the library search results, and transmits the text message to phone 110. The user may then view the text message in a conventional manner.

If the determined type of response comprises a voice message, then processing system 108 may transmit the library search results to intelligent peripheral 121. Intelligent peripheral 121 receives the library search results, generates a voice message based on the library search results, and transmits the voice message to phone 110 or a voice mail server for phone 110. The user may then listen to the voice message in a conventional manner.

If the determined type of response comprises an email message, then processing system 108 may transmit the library search results to email server 122. Email server 122 receives the library search results, generates an email message based on the library search results, and transmits the email message to an email address specified by the user. The user may then view the email message in a conventional manner through phone 110 or another device.

FIG. 4 is a flow chart illustrating a method 400 of further operating phone 110 in an exemplary embodiment of the invention. The assumption for method 400 is that phone 110 received a response message from library server 102. The steps of method 400 will be described with reference to phone 110 in FIG. 1.

In step 402, network interface 116 receives the response message from communication network 100. As described above, the response message includes library search results based on the library search parameter(s). In step 404, processing system 114 processes the library search results to provide a display screen of the library search results to the user through user interface 112. User interface 112 may display all of the search results or a subset of them. For instance, if the library search results include a plurality of records, then user interface 112 may display the entire list of records or a subset of them. The number of records displayed may be set by the user, or may be set by filtering criteria used by processing system 114. If multiple records are listed, user interface 112 allows the user to scroll through the search results.

Communication network 100 and phone 110 advantageously provide a phone library service to a user that was not previously provided. If the user wants to search for information on a book, information on an author, information on a song, etc, the user can enter search parameters into phone 110, and communication network 100 will obtain search results for the user.

### EXAMPLE

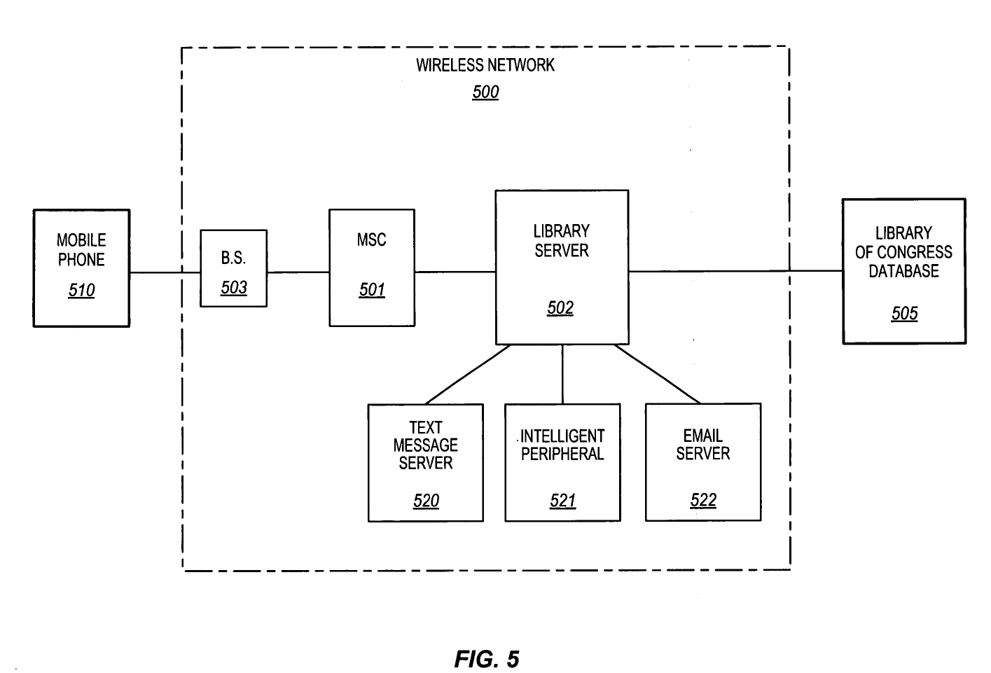

FIGS. 5-7 illustrate an example of using a library service according to features and aspects herein.

FIG. 5 illustrates a wireless network 500 in another exemplary embodiment of the invention. Wireless network 500 includes a base station 503, an MSC 501, and a library server 502. MSC 501 is adapted to communicate with a mobile phone 510 and a plurality of other mobile phones (not shown) through base station 503. MSC 501 is also adapted to communicate with library server 502. Library server 502 is adapted to communicate with a Library of Congress database 505. Wireless network 500 may include other networks, systems, or devices not shown in FIG. 5.

Library of Congress database 505 represents the Library of Congress Online Catalog that stores around 14 million records representing books, serials, computer files, manuscripts, cartographic materials, music, sound recordings, and visual materials. To provide the library service, the service provider operating wireless network 500 may contract with the Library of Congress to obtain the format of query messages needed to acquire information from database 505. The Library of Congress would grant the service provider permission to have library server 502 access the library information in Library of Congress database 505.

The user of mobile phone 510 would subscribe to the library service through the service provider. The user may define preferences for information retrieval. For instance, if the library search results return a single record, then a preference may be to receive the search results as a real-time screen display. If the library search results return a plurality of records in a list, then a preference may be to receive the search results as a text message or an email message.

Assume that the user wants to find information on a book, an article, a song, etc. The user can access the library service through mobile phone 510 to find the desired library information.

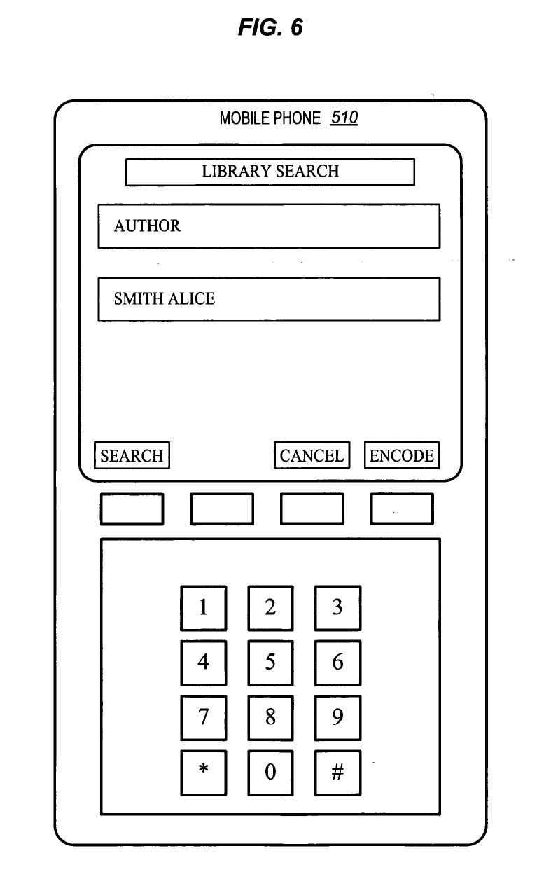

Mobile phone 510 provides a library search screen to the user. The library search screen is not intended to be an HTML search screen provided by Library of Congress database 505 through a web browser on mobile phone 510. The library search screen is a screen generated by mobile phone 510 based on a library service application running on mobile phone 510. The user then enters one or more library search parameters into mobile phone 510 using the keypad (or other input mechanism). In this embodiment, assume the user entered “Alice Smith” and “Author” as the library search parameters. FIG. 6 illustrates an exemplary library search screen provided to the user by mobile phone 510.

Responsive to receiving the search parameters, mobile phone 510 initiates a library search request based on the library search parameters. Mobile phone 510 may dial a number for library server 502 and establish a bearer channel with library server 502 through MSC 501. If a bearer channel is established, mobile phone 510 may transmit a request message to library server 502 over the bearer channel. The request message includes the library search parameters. Mobile phone 510 may alternatively avoid establishing a bearer channel by using signaling/control channels to transmit the request message to library server 502.

Library server 502 receives the request message and parses the library search message to identify the library search parameters. Library server 502 then generates a query message based on a desired format of the Library of Congress database 505, and maps the library search parameters into the query message. Library server 502 then transmits the query message to Library of Congress database 505. The communication path between library server 502 and Library of Congress database 505 may be IP-based or another protocol.

Responsive to the query message, Library of Congress database 505 performs a database search based on the library search parameters. Library of Congress database 505 transmits a search result message back to library server 502 indicating the library search results.

Library server 502 collects and parses the library search results and determines the type of response for the library search results. The type of response may depend on one or more preferences predefined by the user. For instance, if the library search results return a single record, then a preference may be to receive the search results as a real-time screen display. If the library search results return a plurality of records in a list, then a preference may be to receive the search results as a text message or an email message.

The type of response may alternatively be determined by library server 502. Library server 502 may know the display capabilities of mobile phone 510. If the search results include a lower number of records that may be displayed on mobile phone 510, then library server 502 may determine the type of response to be a real-time screen display. If the search results include a larger number of records that cannot be reasonably displayed on mobile phone 510, then library server 502 may determine the type of response to be a text message, an email message, a voice message, etc.

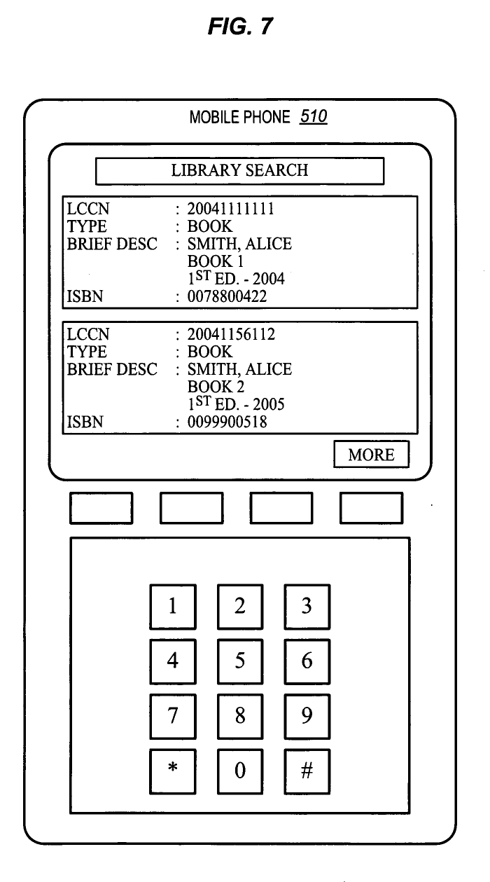

If the determined type of response comprises a real-time screen display to the user, then library server 502 generates a response message that includes the library search results. Library server 502 then transmits the response message to mobile phone 510 through MSC 501. Responsive to the response message, mobile phone 510 parses the response message and displays the library search results to the user. FIG. 7 illustrates an exemplary search results screen provided to the user by mobile phone 510. In this example, mobile phone 510 displays two records of the search results. One record indicates “Book 1” as authored by Alice Smith, and provides a brief description of Book 1. Another record indicates “Book 2” as authored by Alice Smith, and provides a brief description of Book 2. The records may include other information, such as a rating, a reading level, etc.

In FIG. 5, if the determined type of response comprises a text message, then library server 502 may transmit the library search results to text message server 520. Text message server 520 receives the library search results, generates a text message based on the library search results, and transmits the text message to mobile phone 510. The user may then view the text message in a conventional manner.

If the determined type of response comprises a voice message, then library server 502 may transmit the library search results to intelligent peripheral 521. Intelligent peripheral 521 receives the library search results, generates a voice message based on the library search results, and transmits the voice message to mobile phone 510 or a voice mail server for mobile phone 510. The user may then listen to the voice message in a conventional manner.

If the determined type of response comprises an email message, then library server 502 may transmit the library search results to email server 522. Email server 522 receives the library search results, generates an email message based on the library search results, and transmits the email message to an email address specified by the user. The user may then view the email message in a conventional manner through mobile phone 510 or another device.

Although specific embodiments were described herein, the scope of the invention is not limited to those specific embodiments. The scope of the invention is defined by the following claims and any equivalents thereof.

We claim:

1. A method of providing a library service to a user of a phone, the method comprising:
receiving a request message from the phone, wherein the request message includes at least one library search parameter entered by the user of the phone;
querying a library database based on the at least one library search parameter;
receiving library search results from the library database;
determining a type of response for providing the library search results to the user;
formatting the library search results based on the determined type of response; and
transmitting the response to the user.

2. The method of claim 1 wherein the determined type of response comprises a response message to the phone that includes the library search results, wherein the response message causes display of the library search results by the phone to the user.

3. The method of claim 2 wherein the response message comprises a signaling message.

4. The method of claim 1 wherein the determined type of response is a text message to the phone that includes the library search results.

5. The method of claim 1 wherein the determined type of response is a voice message to the phone that includes the library search results.

6. The method of claim 1 wherein the determined type of response is an email message to the user that includes the library search results.

7. The method of claim 1 wherein the type of response is specified by the user.

8. The method of claim 1 wherein the type of response is dynamically determined based on the size of the library search results.

9. The method of claim 1 wherein querying the library database comprises:
generating a query message that includes the library search parameters; and
formatting the query message based on a desired format of the library database.

10. The method of claim 1 wherein the phone comprises a VoIP phone or a mobile phone.

11. A library server of a communication network for providing a library service, the library server comprising:
a phone interface that receives a request message from a phone, wherein the request message includes at least one library search parameter entered by the user of the phone; and
a processing system that queries a library database based on the at least one library search parameter, receives library search results from the library database, determines a type of response for providing the library search results to the user, and formats the library search results based on the determined type of response, and transmits the response to the user.

12. The library server of claim 11 wherein the determined type of response comprises a response message to the phone that includes the library search results, wherein the response message causes display of the library search results by the phone to the user.

13. The library server of claim 12 wherein the response message comprises a signaling message.

14. The library server of claim 11 wherein the determined type of response is a text message to the phone that includes the library search results.

15. The library server of claim 11 wherein the determined type of response is a voice message to the phone that includes the library search results.

16. The library server of claim 11 wherein the determined type of response is an email message to the user that includes the library search results.

17. The library server of claim 11 wherein the type of response is specified by the user.

18. The library server of claim 11 wherein the type of response is dynamically determined based on the size of the library search results.

19. The library server of claim 11 wherein the processing system is further adapted to:
generate a query message that includes the library search parameters; and
format the query message based on a desired format of the library database.

20. The library server of claim 11 wherein the phone comprises a VoIP phone or a mobile phone.
